(19) United States
(12) Patent Application Publication
(10) Pub. No.: US 2022/0172227 A1
(43) Pub. Date: Jun. 2, 2022

(54) COMMODITY DEMAND PREDICTION DEVICE, COMMODITY DEMAND PREDICTION METHOD, AND RECORDING MEDIUM

(71) Applicant: NEC Corporation, Minato-ku, Tokyo (JP)

(72) Inventors: Mitsunori MORISAKI, Tokyo (JP); Hiroki SUGEGAYA, Tokyo (JP)

(73) Assignee: NEC Corporation, Minato-ku, Tokyo (JP)

(21) Appl. No.: 17/437,970

(22) PCT Filed: Feb. 19, 2020
(86) PCT No.: PCT/JP2020/006588

§ 371 Date: Sep. 10, 2021

(30) Foreign Application Priority Data
Mar. 25, 2019 (JP) 2019-055919

(51) Int. Cl. G06Q 30/02

(52) U.S. Cl. CPC G06Q 30/0201; G06Q 30/0206; G06Q 30/0205

(57) ABSTRACT

A commodity demand prediction device according to an aspect of the present disclosure includes: at least one memory configured to store instructions; and at least one processor configured to execute the instructions to: acquire information regarding a person expected to be present in an area where a store is located in at least a part of a time zone in which a demand for a commodity is predicted; and predict the demand for the commodity in the store in the time zone based on the information regarding the person and a purchase tendency of the person for the commodity.

### TECHNICAL FIELD

The present disclosure relates to a commodity demand prediction device, a commodity demand prediction system, a commodity demand prediction method, and a recording medium.

### BACKGROUND ART

In order to improve sales in a retail store (a convenience store, a supermarket, or the like), it is important to predict a commodity demand in the store.

Techniques for predicting a commodity demand in a store are disclosed in, for example, PTLs 1, 2, and 3. In the technique described in PTL 1, the number of sold commodities is calculated for each market of regular customers and floating customers in a trading zone, and sales in a store are predicted. In the technique described in PTL 2, a stock quantity of commodities is adjusted on the basis of a schedule of an event and a correlation between the event and an increase or decrease in sales performance of the commodities. In the technique described in PTL 3, a stock plan is adjusted on the basis of influence information (information regarding an event to be held or the like) that influences sales in a store.

As a related technique, PTL 4 discloses a technique for recommending a commodity or a service on the basis of a behavior schedule.

### CITATION LIST

### Patent Literature

### [PTL 1] JP 2002-324160 A

### [PTL 2] JP 2011-145960 A

### [PTL 3] JP 2002-288496 A

### [PTL 4] JP 2002-259800 A

### SUMMARY OF INVENTION

### Technical Problem

In the above-described patent literatures, there is a possibility that the commodity demand cannot be accurately predicted because information regarding people present in a trading zone at a prediction target time and needs of those people cannot be considered.

An object of the present disclosure is to provide a commodity demand prediction device, a commodity demand prediction system, a commodity demand prediction method, and a recording medium capable of solving the above-described problem and accurately predicting a commodity demand in a store.

### Solution to Problem

A commodity demand prediction device in an aspect of the present disclosure includes: an acquisition means for acquiring information regarding a person expected to be present in an area where a store is installed in at least a part of a time zone in which a demand for a commodity is predicted; and a prediction means for predicting the demand for the commodity in the store in the time zone based on the information regarding the person and a purchase tendency of the person for the commodity.

A first commodity demand prediction system in an aspect of the present disclosure includes: a commodity demand prediction device including an acquisition means for acquiring information regarding a person expected to be present in an area where a store is installed in at least a part of a time zone in which a demand for a commodity is predicted, and a prediction means for predicting the demand for the commodity in the store in the time zone based on the information regarding the person and a purchase tendency of the person for the commodity; and a detection information management device that stores detection information of a person in the area, wherein the acquisition means acquires the information regarding the person by using the detection information of the person in the area, the detection information being acquired from the detection information management device.

A second commodity demand prediction system in an aspect of the present disclosure includes: a commodity demand prediction device including an acquisition means for acquiring information regarding a person expected to be present in an area where a store is installed in at least a part of a time zone in which a demand for a commodity is predicted, and a prediction means for predicting the demand for the commodity in the store in the time zone based on the information regarding the person and a purchase tendency of the person for the commodity; and a schedule information management device that stores schedule information of a person related to the area, wherein the acquisition means acquires the information regarding the person by using the schedule information of the person related to the area, the schedule information being acquired from the schedule information management device.

A commodity demand prediction method in an aspect of the present disclosure includes: acquiring information regarding a person expected to be present in an area where a store is installed in at least a part of a time zone in which a demand for a commodity is predicted; and predicting the demand for the commodity in the store in the time zone based on the information regarding the person and a purchase tendency of the person for the commodity.

A computer-readable recording medium in an aspect of the present disclosure stores a program that causes a computer to execute processing including: acquiring information regarding a person expected to be present in an area where a store is installed in at least a part of a time zone in which a demand for a commodity is predicted; and predicting the demand for the commodity in the store in the time zone based on the information regarding the person and a purchase tendency of the person for the commodity.

### Advantageous Effects of Invention

An effect of the present disclosure is to accurately predict a commodity demand in a store.

### BRIEF DESCRIPTION OF DRAWINGS

FIG. 1 is a block diagram illustrating an overall configuration of a commodity demand prediction system 10 in a first example embodiment.

FIG. 2 is a diagram illustrating an example of detection information in the first example embodiment.

FIG. 3 is a diagram illustrating another example of the detection information in the first example embodiment.

FIG. 4 is a diagram illustrating an example of schedule information in the first example embodiment.

FIG. 5 is a block diagram illustrating details of a configuration of a POS device 510 in the first example embodiment.

FIG. 6 is a diagram illustrating an example of purchase data in the first example embodiment.

FIG. 7 is a block diagram illustrating details of a configuration of a store server 520A in the first example embodiment.

FIG. 8 is a block diagram illustrating details of a configuration of a store server 520B in the first example embodiment.

FIG. 9 is a diagram illustrating an example of a purchase history in the first example embodiment.

FIG. 10 is a diagram illustrating an example of purchase tendency information in the first example embodiment.

FIG. 11 is a diagram illustrating another example of the purchase tendency information in the first example embodiment.

FIG. 12 is a diagram illustrating an example of expected stay information in the first example embodiment.

FIG. 13 is a diagram illustrating another example of the expected stay information in the first example embodiment.

FIG. 14 is a flowchart illustrating purchase tendency generation processing in the first example embodiment.

FIG. 15 is a flowchart illustrating commodity demand prediction processing in the first example embodiment.

FIG. 16 is a diagram illustrating an example of a commodity demand prediction result in the first example embodiment.

FIG. 17 is a diagram illustrating an example of a prediction result screen in the first example embodiment.

FIG. 18 is a diagram illustrating an example of the purchase tendency information in a fourth modified example of the first example embodiment.

FIG. 19 is a block diagram illustrating details of configurations of a store server 520B and a headquarter server 610 in a second example embodiment.

FIG. 20 is a flowchart illustrating commodity demand prediction processing in the second example embodiment.

FIG. 21 is a diagram illustrating an example of a prediction result screen in the second example embodiment.

FIG. 22 is a block diagram illustrating details of configurations of a store server 520B and a headquarter server 610 in a third example embodiment.

FIG. 23 is a block diagram illustrating details of configurations of a store server 520B and a headquarter server 610 in a fourth example embodiment.

FIG. 24 is a block diagram illustrating details of configurations of store servers 520A and 520B in a fifth example embodiment.

FIG. 25 is a block diagram illustrating details of configurations of a store server 520B and a headquarter server 610 in a sixth example embodiment.

FIG. 26 is a block diagram illustrating an example of a hardware configuration of a computer 900 in the example embodiments.

FIG. 27 is a block diagram illustrating a configuration of a store server 520B in a seventh example embodiment.

### EXAMPLE EMBODIMENT

Example embodiments will be described in detail with reference to the drawings. In the drawings and the example embodiments described in the specification, the same reference signs are given to similar components, and a description thereof will be omitted as appropriate.

### First Example Embodiment

A first example embodiment will be described.

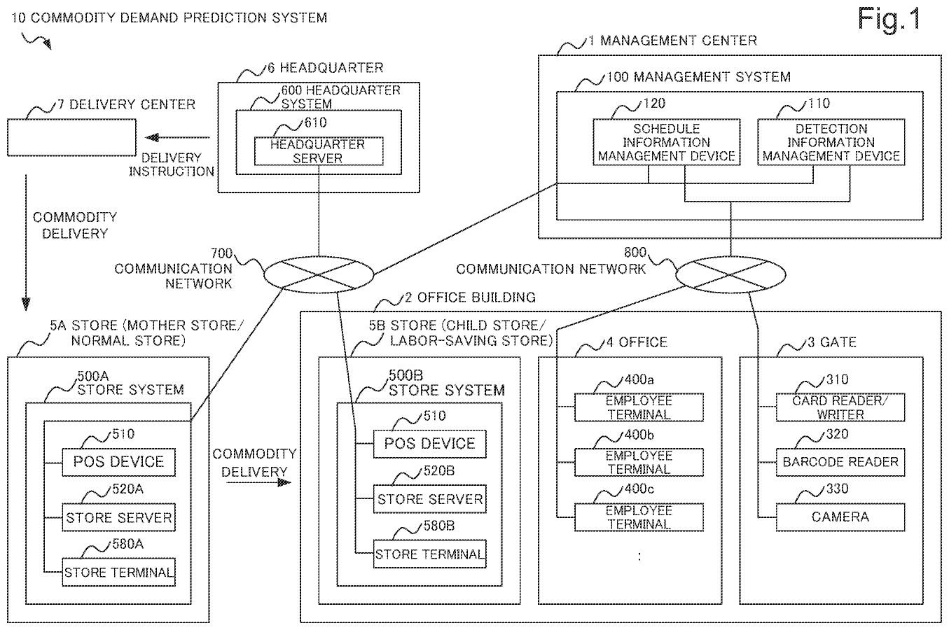

First, a configuration of a commodity demand prediction system 10 in the first example embodiment will be described. FIG. 1 is a block diagram illustrating the overall configuration of the commodity demand prediction system 10 in the first example embodiment. The commodity demand prediction system 10 is a system that predicts a commodity demand in a store. The prediction target store sells a commodity to a person present in a certain area. The area indicates a range of a place distinguished from other places, which includes, for example, an area in a structure, such as a floor in a building, a structure such as a building, a structure group such as adjacent or close buildings, and a site including such a structure or structure group.

Here, the example embodiments will be described with an example in which the above-described area is an office building of a company, and the store sells the commodity to employees of the company present in the office building. In addition, an employee ID of an employee is used as an identifier (hereinafter, also referred to as an identifier (ID)) for identifying a person present in the area.

Referring to FIG. 1, the commodity demand prediction system 10 in the first example embodiment includes a management system 100, store systems 500A and 500B (hereinafter, collectively referred to as a store system 500 as well), and a headquarter system 600.

The management system 100 is installed in a management center 1. The management center 1 is a management department that manages various facilities of an office building 2, the employees of the company, and the like.

The store systems 500A and 500B are installed in stores 5A and 5B (hereinafter, collectively referred to as a store 5 as well), respectively. The stores 5A and 5B are stores such as a chain of convenience stores or supermarkets.

Among the stores 5A and 5B, for example, the store 5A is installed outside the office building 2 and near the office building 2, and the store 5B is installed in the office building 2. The store 5A is a mother store of the store 5B, and manages the store 5B. The store 5B is a child store of the store 5A.

Furthermore, the store 5A is, for example, a normal store in the above-described chain, and the store 5B is a labor-saving store or an unmanned store. Each of the labor-saving store and the unmanned store is a small store in which work of salesclerks, which relates to registration and checkout of commodities to be purchased, customer service support, in-store monitoring, inventory management, facility management, and the like, is reduced by use of a computer system for the purpose of improving work efficiency and expanding the business to a small trading zone, so that the number of stationed salesclerks is reduced as compared with the normal store or reduced to zero. Commodities to be sold in the store 5B are ordered from the store 5A or the store 5B to a headquarter 6, and are delivered from a delivery center 7 to the store 5A together with commodities of the store 5A on the basis of a delivery instruction from the headquarter 6. The commodities of the store 5B are further delivered from the store 5A to the store 5B by, for example, a salesclerk or the like of the store 5A, and are stacked (displayed) on a display shelf or the like of the store 5B.

Note that both the stores 5A and 5B may be normal stores, or both the stores 5A and 5B may be labor-saving stores or unmanned stores. In addition, the commodities to be sold in the store 5B may be directly delivered from the delivery center 7 to the store 5A.

The store system 500A includes a point of sale (POS) device 510, a store server 520A, and a store terminal 580A.

The store system 500B includes a POS device 510, a store server 520B, and a store terminal 580B. Hereinafter, the store servers 520A and 520B are collectively referred to as a store server 520 as well, and the store terminals 580A and 580B are collectively referred to as a store terminal 580 as well.

In each store system 500, the POS device 510, the store server 520, and the store terminal 580 are connected by, for example, an in-store network.

In the office building 2, a gate 3 and an office 4 are further installed. The gate 3 is a doorway of the office building 2. The office 4 is a place where the employees of the company engage in work.

The headquarter system 600 is installed in the headquarter 6 of the above-described chain. The headquarter 6 is a department that manages the store 5 of the chain.

The management system 100, the store system 500, and the headquarter system 600 are connected by a communication network 700.

A card reader/writer 310, a barcode reader 320, and a camera 330 installed in the gate 3 are connected to the management system 100 through a communication network 800 in the company. The card reader/writer 310 is a device that reads and writes information from and to a magnetic card or a contactless integrated circuit (IC) card. The barcode reader 320 is a device that reads a barcode. The camera 330 is an imaging device that acquires an image of an employee or the like.

In addition, employee terminals 400a, 400b, and the like (hereinafter, collectively referred to as an employee terminal 400 as well) installed in the office 4 may be connected to the management system 100 through the communication network 800. The employee terminal 400 is a terminal device used by each employee in work.

The management system 100 includes a detection information management device 110 and a schedule information management device 120.

The detection information management device 110 stores detection information of an employee (person) in the office building 2 (area). The detection information is information indicating the employee detected in the office building 2 (present in the office building 2).

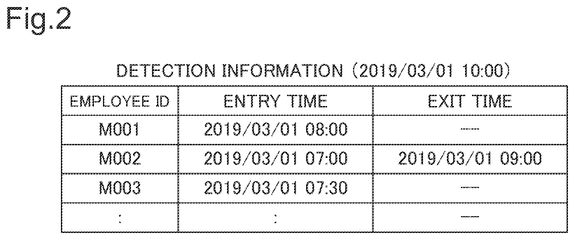

The detection information is, for example, information indicating an entry/exit status of the employee (person) in the office building 2 (area). FIG. 2 is a diagram illustrating an example of the detection information in the first example embodiment. In this case, as illustrated in FIG. 2, the employee ID, an entry time, and an exit time are set in the detection information in association with each other. The entry time indicates a time when the employee indicated by the employee ID enters the office building 2. The exit time indicates a time when the employee exits from the office building 2. The entry time is set when the entry of the employee is detected. The exit time is initialized when the entry of the employee is detected and set when the exit is detected.

The detection information management device 110 uses the card reader/writer 310, the barcode reader 320, and the camera 330 to acquire the employee ID of the employee that enters the office building 2 or exits from the office building 2 through the gate 3. For example, the detection information management device 110 acquires, from the card reader/writer 310, the employee ID read from the magnetic card or an employee ID card in a contactless IC card format, which is owned by the employee. In addition, the detection information management device 110 may acquire, from the barcode reader 320 or the camera 330, information of a barcode or a two-dimensional barcode indicating the employee ID read from the employee ID card. In addition, the detection information management device 110 may acquire a face image of the employee from the camera 330 and specify the employee ID by face image authentication. Similarly, the detection information management device 110 may specify the employee ID by another biometric authentication means other than the face image authentication, such as iris authentication, fingerprint authentication, or vein authentication, using another sensor installed in the gate 3.

Note that, as long as the employee present in the office building 2 can be detected, the card reader/writer 310, the barcode reader 320, the camera 330, and another sensor may be installed in any place other than the gate 3, such as a passage in the office building 2 or a doorway of each office 4.

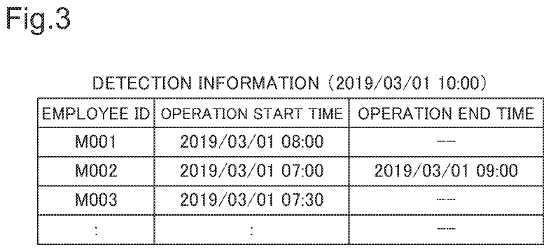

Furthermore, the detection information may be information indicating an operation status of the employee terminal 400 of the employee (a terminal device of a person) in the office building 2 (area). FIG. 3 is a diagram illustrating another example of the detection information in the first example embodiment. In this case, as illustrated in FIG. 3, the employee ID, an operation start time, and an operation end time are set in the detection information in association with each other. The operation start time indicates a time when an operation of the employee terminal 400 of the employee indicated by the employee ID is started by the employee. The operation end time indicates a time when the operation of the employee terminal 400 is ended by the employee. The operation start time is set when the start of the operation of the employee terminal 400 is detected. The operation end time is initialized when the start of the operation of the employee terminal 400 is detected and set when the end of the operation is detected.

The operation start time and the operation end time are, for example, a time when the employee activates the employee terminal 400 and a time when the employee stops the employee terminal 400, respectively. The operation start time and the operation end time may be a time when the employee logs in to the employee terminal 400 and a time when the employee logs off the employee terminal 400, respectively, or may be a time when the employee logs in to a server device (not illustrated) for work, which is connected to the communication network 800 via the employee terminal 400, and a time when the employee logs off the server device, respectively.

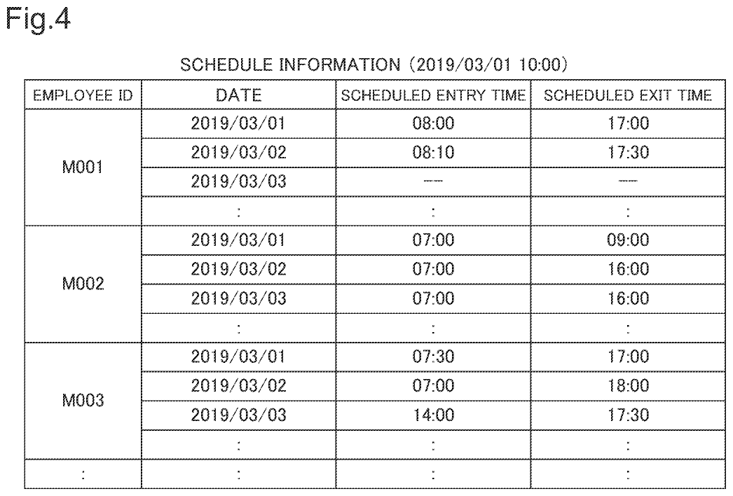

The schedule information management device 120 stores schedule information of an employee (person) related to the office building 2 (area). The schedule information is information indicating a schedule of the employee working in the office building 2. FIG. 4 is a diagram illustrating an example of the schedule information in the first example embodiment. As illustrated in FIG. 4, the employee ID, a scheduled entry time of each day, and a scheduled exit time of each day are set in the schedule information in association with each other. The employee ID indicates an employee ID of the employee working in the office building 2. The scheduled entry time indicates a scheduled time when the employee enters the office building 2. The scheduled entry time may be a scheduled time when the employee arrives at the office building 2, or may be a scheduled time when the employee returns to the office building 2 from an outing. The scheduled exit time indicates a scheduled time when the employee exits from the office building 2. The scheduled exit time may be a scheduled time when the employee leaves the office building 2, or may be a scheduled time when the employee departs from the office building 2 for an outing. The schedule of each employee in the schedule information is registered by each employee via the employee terminal 400 or the like, for example.

Note that the schedule information may include a schedule of an employee working in a place other than the office building 2. In this case, in the schedule information, for example, a scheduled time when the employee starts to visit the office building 2 is set as the scheduled entry time, and a scheduled time when the employee finishes visiting the office building 2 is set as the scheduled exit time.

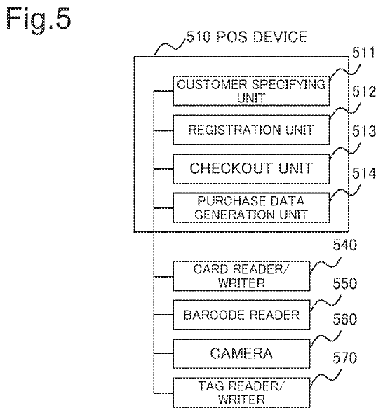

FIG. 5 is a block diagram illustrating details of a configuration of the POS device 510 in the first example embodiment. As illustrated in FIG. 5, a card reader/writer 540, a barcode reader 550, a camera 560, and a tag reader/writer 570 may be connected to the POS device 510. The card reader/writer 540, the barcode reader 550, the camera 560, and the tag reader/writer 570 are installed, for example, near the POS device 510. The card reader/writer 540 is a device that reads and writes information from and to a magnetic card or a contactless IC card. The barcode reader 550 is a device that reads a barcode. The camera 560 is an imaging device that acquires an image of a commodity, an employee, or the like. The tag reader/writer 570 is a device that reads and writes information from and to a radio frequency identifier (RFID) tag.

Referring to FIG. 5, the POS device 510 includes a customer specifying unit 511, a registration unit 512, a checkout unit 513, and a purchase data generation unit 514.

The customer specifying unit 511 specifies an employee ID (person ID) of an employee (person) as a customer who purchases a commodity in the store 5. The customer specifying unit 511 uses the card reader/writer 540, the barcode reader 550, or the camera 560 to acquire (specify) the employee ID of the employee by an employee ID card or face authentication similarly to the detection information management device 110 described above.

The customer specifying unit 511 outputs the acquired employee ID to the purchase data generation unit 514.

The registration unit 512 registers the commodity to be purchased by the employee as the customer in the store 5. The registration unit 512 uses the barcode reader 550, the camera 560, or the tag reader/writer 570 to acquire a commodity ID of the commodity to be purchased by the employee. The commodity ID is an identifier for identifying the commodity. As the commodity ID, for example, a commodity name or a commodity code is used. For example, the registration unit 512 may acquire, from the barcode reader 550 or the camera 560, information of a barcode or a two-dimensional barcode indicating the commodity ID read from the commodity. Furthermore, the registration unit 512 may acquire an image of the commodity from the camera 560 and specify the commodity ID by image recognition. In addition, the registration unit 512 may acquire, from the tag reader/writer 570, the commodity ID read from an RFID tag of the commodity.

The registration unit 512 outputs the acquired commodity ID of the commodity to be purchased by the employee to the checkout unit 513.

The checkout unit 513 checks out (makes payment for) the commodity to be purchased by the employee as the customer (the commodity with the commodity ID acquired by the registration unit 512). The checkout unit 513 uses the card reader/writer 540, the barcode reader 550, or the camera 560 to acquire information necessary for checkout (payment), and checks out (makes payment). For example, the checkout unit 513 acquires, from the card reader/writer 540, the information necessary for payment read from a credit card or an electronic money card in a magnetic form or a contactless IC card form, which is presented by the employee. In addition, the checkout unit 513 acquires, from the barcode reader 550 or the camera 560, information of a barcode or a two-dimensional barcode for payment read from a payment application operating on a terminal of the employee. In addition, the checkout unit 513 may acquire a face image of the employee from the camera 560, specify the employee ID by face image authentication, and acquire information of a credit card, electronic money, a bank account, or the like registered in advance in association with the employee ID. Similarly, the checkout unit 513 may specify the employee ID by another biometric authentication means other than the face image authentication, such as iris authentication, fingerprint authentication, or vein authentication, using another sensor. In addition, the checkout unit 513 may check out by exchange of cash by a salesclerk or exchange of cash by use of an automatic change machine (not illustrated) connected to the POS device 510.

Note that, the registration and the checkout of the commodity may be performed by, for example, an operation of the salesclerk of the store 5, or may be performed by an operation of the employee as the customer. In addition, the registration of the commodity may be performed by the operation of the salesclerk of the store 5, and the checkout may be performed by the operation of the employee as the customer.

When the checkout is completed, the checkout unit 513 outputs, to the purchase data generation unit 514, the commodity ID of the commodity for which the checkout is completed (the commodity purchased by the employee) and a time when the checkout is completed (purchase time).

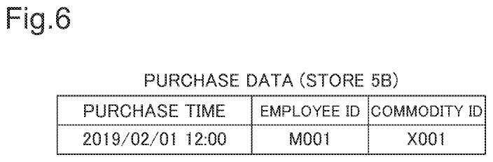

The purchase data generation unit 514 generates purchase data by using the employee ID input from the registration unit 512 and the commodity ID and the purchase time input from the checkout unit 513, and transmits the purchase data to the store server 520 of the own store. FIG. 6 is a diagram illustrating an example of the purchase data in the first example embodiment. As illustrated in FIG. 6, the purchase time, the employee ID, and the commodity ID are set in the purchase data in association with each other. The purchase time indicates the time when the commodity has been purchased. The employee ID indicates the employee ID of the employee who has purchased the commodity. The commodity ID indicates the commodity ID of the purchased commodity.

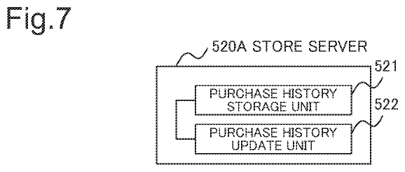

FIG. 7 is a block diagram illustrating details of a configuration of the store server 520A in the first example embodiment. Referring to FIG. 7, the store server 520A includes a purchase history storage unit 521 and a purchase history update unit 522.

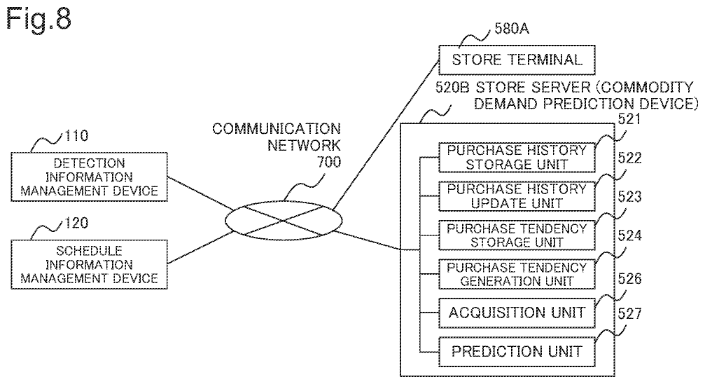

FIG. 8 is a block diagram illustrating details of a configuration of the store server 520B in the first example embodiment. Referring to FIG. 8, the store server 520B includes a purchase tendency storage unit 523, a purchase tendency generation unit 524, an acquisition unit 526, and a prediction unit 527 in addition to a purchase history storage unit 521 and a purchase history update unit 522 similar to those of the store system 500A.

The purchase history storage unit 521 stores a purchase history. The purchase history indicates a purchase history of the employee for the commodity in the own store 5.

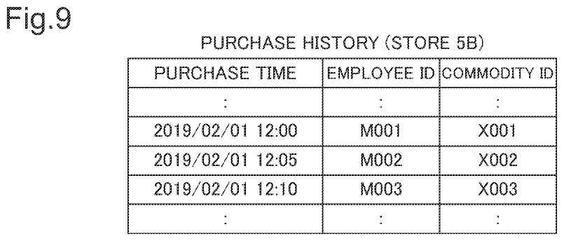

FIG. 9 is a diagram illustrating an example of the purchase history in the first example embodiment. As illustrated in FIG. 9, in the purchase history, the purchase data received from the POS device 510 of the own store 5 is set in order of the purchase time.

The purchase history update unit 522 updates the purchase history in the purchase history storage unit 521 with the purchase data received from the POS device 510 of the own store 5.

The purchase tendency storage unit 523 stores purchase tendency information indicating a purchase tendency of the employee (person) for the commodity. The purchase tendency indicates a purchase possibility of the commodity.

The purchase tendency generation unit 524 generates the purchase tendency information on the basis of the purchase history in the purchase history storage unit 521, and stores the purchase tendency information in the purchase tendency storage unit 523. The purchase tendency is indicated by, for example, the following purchase ratio.

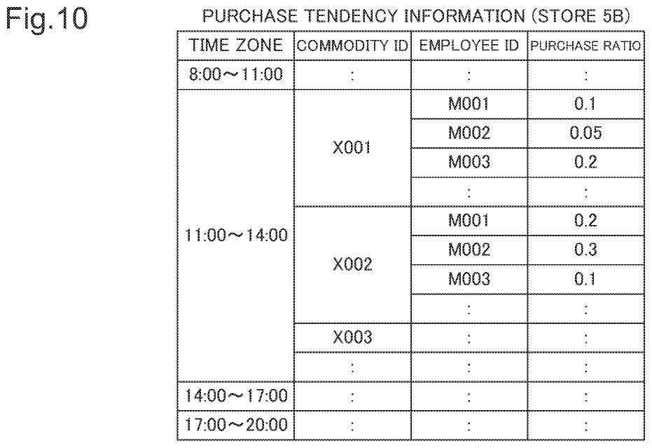

FIG. 10 is a diagram illustrating an example of the purchase tendency information in the first example embodiment. In the example of FIG. 10, a time zone, the commodity ID, the employee ID, and the purchase ratio are set in the purchase tendency information in association with each other. The time zone indicates, for example, each section of time obtained by dividing one day by a predetermined method (for example, every several hours). Note that the time zone may be each section obtained by dividing one year by a predetermined method (for example, each season, each month, or the like), each section obtained by dividing one month by a predetermined method (each day or the like), or each section obtained by dividing one week by a predetermined method (each day of the week or the like). Here, the purchase ratio indicates, for each time zone, a ratio of the number of times the commodity indicated by the commodity ID has been purchased by the employee in the time zone to the number of times obtained by counting, as one time, a case where the employee indicated by the employee ID is present in the office building 2 in at least a part of the time zone. The purchase tendency generation unit 524 calculates the purchase ratio for each combination of the time zone, the commodity, and the employee on the basis of the purchase history for a predetermined period (for example, latest one year, one month, or one week).

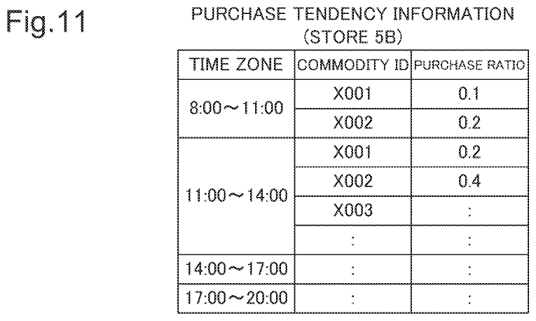

FIG. 11 is a diagram illustrating another example of the purchase tendency information in the first example embodiment. In the example of FIG. 11, the time zone, the commodity ID, and the purchase ratio are set in the purchase tendency information in association with each other. Here, the purchase ratio indicates, for each time zone, a ratio of the number of employees who have purchased the commodity indicated by the commodity ID to the number of employees present in the office building 2 in the time zone. The purchase tendency generation unit 524 calculates the purchase ratio for each combination of the time zone and the commodity on the basis of the purchase history for a predetermined period.

The acquisition unit 526 acquires expected stay information. The expected stay information is information regarding an employee (person) expected to be present in the office building 2 (area) in at least a part of a time zone in which a demand for the commodity is predicted (hereinafter, also referred to as target time zone).

For example, the acquisition unit 526 acquires the above-described detection information from the detection information management device 110, and generates (acquires) the expected stay information from the detection information. Furthermore, the acquisition unit 526 may acquire the above-described schedule information from the schedule information management device 120, and generate (acquire) the expected stay information from the schedule information.

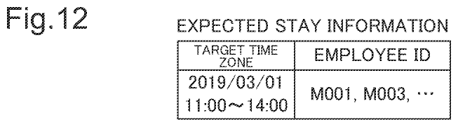

FIG. 12 is a diagram illustrating an example of the expected stay information in the first example embodiment. The information regarding the employee (person) in the expected stay information indicates, for example, an employee ID of the employee (an identifier of the person) expected to be present in the office building 2. In this case, as illustrated in FIG. 12, the target time zone and the employee ID are set in the expected stay information in association with each other. The employee ID indicates the employee ID of the employee expected to be present in the office building 2 in at least a part of the target time zone.

The acquisition unit 526 acquires the detection information as illustrated in FIG. 2, for example, at a time when the prediction of the commodity demand is executed (hereinafter, also referred to as an execution time) in or before the target time zone, and extracts an employee ID of an employee whose entry time is set but whose exit time is not set. In addition, the acquisition unit 526 may acquire the detection information as illustrated in FIG. 3 and extract an employee ID of an employee whose operation start time is set but whose operation end time is not set. The acquisition unit 526 sets the extracted employee ID as the employee ID of the employee expected to be present in the office building 2. For example, in a company with fewer outings, an employee who has entered the office building 2 by a clock-in time is expected to stay in the office building 2 until a clock-out time. In this case, the execution time is set to a time on or after the clock-in time and in or before the target time zone, and the target time zone is set to a time zone on or after the execution time and on or before the clock-in time, so that the employee ID can be predicted by the above method.

In addition, the acquisition unit 526 may acquire the schedule information as illustrated in FIG. 4 at the execution time, and extract an employee ID of an employee whose working hours as a time zone between the scheduled entry time and the scheduled exit time overlap with the target time zone. The acquisition unit 526 sets the extracted employee ID of the employee as the employee ID of the employee expected to be present in the office building 2.

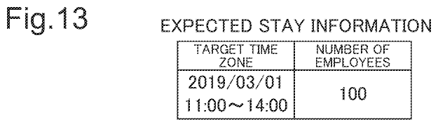

FIG. 13 is a diagram illustrating another example of the expected stay information in the first example embodiment. The information regarding the employee (person) in the expected stay information may indicate the number of employees (the number of persons) expected to be present in the office building 2. In this case, as illustrated in FIG. 13, the target time zone and the number of employees are set in the expected stay information in association with each other. The number of employees indicates the number of employees expected to be present in the office building 2 in at least a part of the target time zone.

For example, the acquisition unit 526 sets, as the number of employees expected to be present in the office building 2, the number of employees extracted from the detection information as illustrated in FIG. 2 or 3 at the execution time as described above.

Furthermore, the acquisition unit 526 may set, as the number of employees expected to be present in the office building 2, the number of employees extracted from the schedule information as illustrated in FIG. 4 at the execution time as described above.

The acquisition unit 526 may further set, as the number of employees, the number obtained by multiplying the number of employees extracted from the detection information by a predetermined coefficient associated to the execution time, the target time zone, a time difference between the execution time and the target time zone, or the like. The predetermined coefficient is determined in advance on the basis of, for example, past detection information.

Note that, instead of the acquisition unit 526, the detection information management device 110 may generate the expected stay information from the detection information, and the acquisition unit 526 may acquire the expected stay information (the employee ID or the number of employees) from the detection information management device 110. Similarly, the schedule information management device 120 may generate the expected stay information from the schedule information, and the acquisition unit 526 may acquire the expected stay information (the employee ID or the number of employees) from the schedule information management device 120.

In this case, the expected stay information may be an attendance ratio (a ratio of employees who have entered the office building 2 to the total number of employees in the office building 2). The acquisition unit 526 can calculate the number of employees by multiplying the attendance ratio by the total number of employees.

The acquisition unit 526 outputs the acquired expected stay information to the prediction unit 527.

The prediction unit 527 predicts the demand for the commodity (hereinafter, also referred to as a commodity demand) in the store 5B in the target time zone on the basis of the information regarding the employee (person) expected to be present in the office building 2 in at least a part of the target time zone and the purchase tendency of the employee (person) for the commodity. The commodity demand is the number or quantity of commodities required by the employee (expected to be purchased by the employee) (hereinafter, also referred to as a demand number or demand quantity). In addition, the commodity demand may be a level indicating the magnitude of the demand number or demand quantity (hereinafter, also referred to as a demand level). Here, the prediction unit 527 predicts the commodity demand on the basis of the purchase tendency information in the purchase tendency storage unit 523 and the expected stay information acquired by the acquisition unit 526. Details of a method for predicting the commodity demand will be described later.

The prediction unit 527 further transmits (outputs) the predicted commodity demand (demand prediction result) to the store terminal 580.

The store terminal 580 is a terminal used by the salesclerk of the store 5. The store terminal 580A of the store 5A requests the store server 520B of the store 5B to predict the commodity demand (transmits a demand prediction request). In addition, the store terminal 580A displays the demand prediction result received from the store server 520B.

The headquarter server 610 instructs the delivery center 7 or the like to deliver the commodity to the store 5A in response to an order request received from the store system 500A or 500B.

The store server 520B, the acquisition unit 526, and the prediction unit 527 in the first example embodiment are example embodiments of a commodity demand prediction device, an acquisition means, and a prediction means in the present disclosure, respectively.

Next, an operation of the first example embodiment will be described.

First, purchase tendency generation processing will be described.

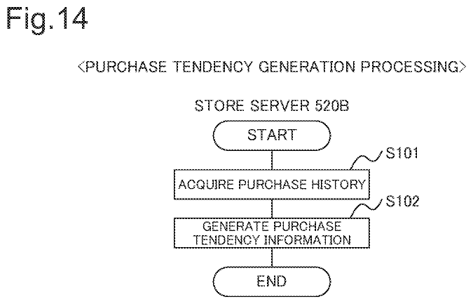

FIG. 14 is a flowchart illustrating the purchase tendency generation processing in the first example embodiment. The purchase tendency generation processing is executed at a predetermined timing, for example, every day, on a predetermined day of the week, at a predetermined time on a predetermined day of every month, or the like.

Here, it is assumed that the purchase history storage unit 521 of the store server 520B stores the purchase history as illustrated in FIG. 9 based on the purchase data of the store 5B.

The purchase tendency generation unit 524 of the store server 520B acquires the purchase history for a predetermined period from the purchase history storage unit 521 (step S101).

The purchase tendency generation unit 524 generates the purchase tendency information on the basis of the acquired purchase history (step S102). The purchase tendency generation unit 524 stores the generated purchase tendency information in the purchase tendency storage unit 523.

For example, the purchase tendency generation unit 524 of the store server 520B generates the purchase tendency information illustrated in FIG. 10 or 11 on the basis of the purchase history illustrated in FIG. 9.

Next, commodity demand prediction processing will be described.

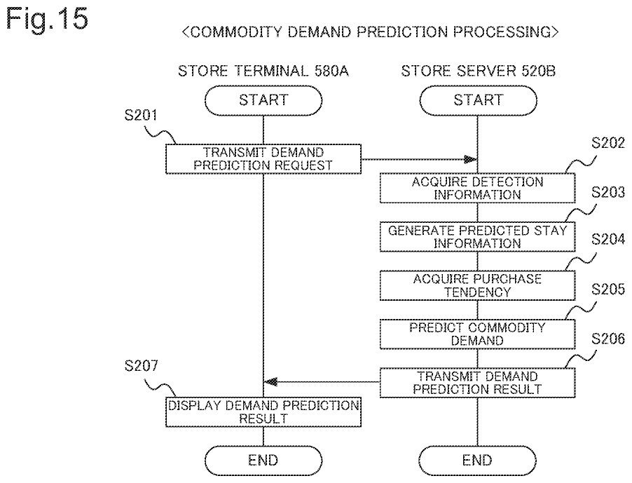

FIG. 15 is a flowchart illustrating the commodity demand prediction processing in the first example embodiment. The commodity demand prediction processing is executed, for example, when the salesclerk of the store 5A performs an operation of displaying the prediction of the commodity demand on the store terminal 580A.

Here, it is assumed that the purchase tendency storage unit 523 of the store server 520B stores the purchase tendency information as illustrated in FIG. 10 or 11.

The store terminal 580A transmits the demand prediction request to the store server 520B of the store 5B (step S201). Here, the store terminal 580A accepts, from the salesclerk, designation of the target time zone and the commodity ID of the commodity for which the demand is predicted, and transmits the demand prediction request including the designation.

For example, the store terminal 580A transmits the demand prediction request including a target time zone “2019/03/01 11:00-14:00” and commodity IDs “X001” and “X002” to the store server 520B at the current time “2019/03/01 10:00”.

The acquisition unit 526 of the store server 520B acquires the detection information from the detection information management device 110 or the schedule information management device 120 (step S202).

The acquisition unit 526 generates the expected stay information from the detection information acquired in step S202 (step S203). The acquisition unit 526 generates the expected stay information for the target time zone included in the demand prediction request.

The prediction unit 527 acquires the purchase tendency information from the purchase tendency storage unit 523. The prediction unit 527 then acquires, from the purchase tendency information, a purchase tendency associated with a set of the target time zone, the commodity ID included in the demand prediction request, and the employee ID included in the expected stay information (step S204).

The prediction unit 527 predicts the demand for the commodity in the target time zone on the basis of the purchase tendency acquired in step S204 and the expected stay information generated in step S203 (step S205).

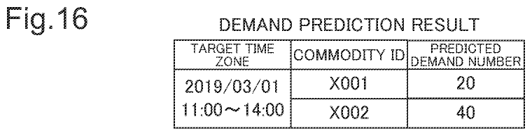

FIG. 16 is a diagram illustrating an example of a commodity demand result in the first example embodiment. For example, the acquisition unit 526 acquires, from the detection information management device 110, the detection information at the current time “2019/03/01 10:00” as illustrated in FIG. 2 or 3. The acquisition unit 526 generates, on the basis of the detection information in FIG. 2 or 3, the expected stay information including employee IDs “M001”, “M003”, and the like for the target time zone “2019/03/01 11:00-14:00” as illustrated in FIG. 12. The prediction unit 527 acquires, from the purchase tendency information in FIG. 10, purchase ratios associated with sets of the target time zone “2019/03/01 11:00-14:00”, each of the commodity IDs“X001” and “X002”, and the employee IDs“M001” and “M003”. The prediction unit 527 calculates a predicted demand number of commodities with the commodity IDs “X001” and “X002” as illustrated in FIG. 16 by summing the purchase ratios acquired for the commodity IDs.

Furthermore, for example, the acquisition unit 526 acquires, from the schedule information management device 120, the schedule information at the current time “2019/03/01 10:00” as illustrated in FIG. 4. The acquisition unit 526 generates, on the basis of the schedule information in FIG. 4, the expected stay information indicating the number of employees “100” for the target time zone “2019/03/01 11:00-14:00” as illustrated in FIG. 13. The prediction unit 527 acquires, from the purchase tendency information in FIG. 11, purchase ratios associated with sets of the target time zone “2019/03/01 11:00-14:00”, and each of the commodity IDs“X001” and “X002”. The prediction unit 527 calculates the predicted demand number of commodities with the commodity IDs “X001” and “X002” as illustrated in FIG. 16 by multiplying the number of employees “100” by the purchase ratios acquired for the commodities.

The prediction unit 527 transmits the demand prediction result to the store terminal 580A (step S206). Here, the prediction unit 527 transmits the commodity IDs of the commodities for which the demand has been predicted and the demand number, demand quantity, or demand level of commodities.

For example, the prediction unit 527 transmits the demand prediction result as illustrated in FIG. 16.

The store terminal 580A of the store 5A displays the demand prediction result received from the store server 520B (step S207).

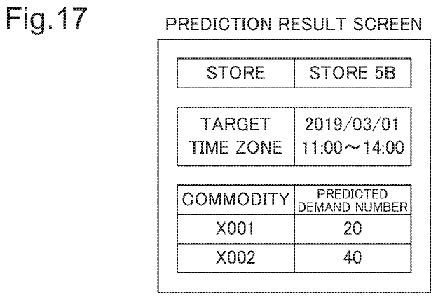

FIG. 17 is a diagram illustrating an example of a prediction result screen in the first example embodiment. In the example of FIG. 17, the predicted demand number is set for the commodities with the commodity IDs “X001” and “X002”. For example, the store terminal 580A displays the prediction result screen in FIG. 17 to the salesclerk.

The salesclerk of the store 5A can refer to the demand for the commodity displayed on the prediction result screen, determine the number or quantity of commodities to be delivered to the store 5B, deliver the commodities to the store 5B, and stack (display) the commodities.

Thus, the operation of the first example embodiment is completed.

According to the first example embodiment, a commodity demand in a store can be accurately predicted. This is because the acquisition unit 526 of the store server 520B acquires information regarding a person expected to be present in an area where the store 5B is installed in at least a part of a time zone in which a demand for a commodity is predicted, and the prediction unit 527 predicts the demand for the commodity in the store 5B in the time zone on the basis of the information regarding the person and a purchase tendency of the person for the commodity.

### Modified Example of First Example Embodiment

The commodity demand prediction system 10 of the first example embodiment can be modified in several ways. Hereinafter, modified examples will be described.

### First Modified Example

In the first example embodiment, the store terminal 580A of the store 5A transmits the demand prediction request to the store server 520B of the store 5B, and displays the demand prediction result received from the store server 520B. However, the present disclosure is not limited to this, and the store terminal 580B of the store 5B may transmit the demand prediction request to the store server 520B and display the demand prediction result received from the store server 520B. As a result, the salesclerk of the store 5B can stack (display) commodities in stock in the store 5B or request the store 5A to deliver commodities according to the demand prediction result.

### Second Modified Example

In the first example embodiment, the prediction unit 527 of the store server 520B transmits the demand prediction result to the store terminal 580A. However, the present disclosure is not limited to this, and the prediction unit 527 may transmit (output) the demand prediction result to the employee terminal 400 or another terminal device (not illustrated) owned by the employee. In this case, for example, the prediction unit 527 transmits the demand prediction result to the employee terminal 400 of the employee expected to be present in the office building 2 in at least a part of the target time zone, which is acquired by the acquisition unit 526. As a result, the employee can know a demand for a commodity, which can help, for example, determine a purchase timing of a commodity in high demand.

Furthermore, the prediction unit 527 may transmit (output) the demand prediction result to the headquarter server 610 of the headquarter system 600 or a terminal device (not illustrated) in the headquarter system 600. As a result, a manager of the chain in the headquarter 6 can know a demand for a commodity in the store 5B, which can help, for example, determine the number or quantity of commodities to be prepared in the delivery center 7.

### Third Modified Example

In the first example embodiment, the area is the office building 2 of the company, and the store 5B is the store installed in the office building 2. However, the area may be other than the office building 2 as long as the information regarding the person expected to be present in the area in the target time zone can be acquired. For example, the area may be a building group constituted by a plurality of adjacent or close office buildings, and the store 5B may be a store installed in any of the plurality of office buildings. In this case, the acquisition unit 526 acquires information regarding a person expected to be present in the area (building group) by using detection information or schedule information of employees of the office buildings.

Furthermore, the area may be a facility such as a school, a hospital, a hotel, a hall, a stadium, or a public facility, or a site including the facility, and the store 5B may be installed in such a facility or site. In this case, the acquisition unit 526 acquires information regarding a person expected to be present in such a facility or site by using detection information of a person in the facility or the site or schedule information of a person related to the facility or the site. In this case, the detection information of the person may be detection information obtained from information regarding entry into and exit from the facility or the site. In addition, the schedule information may be schedule information registered in a scheduler service provided on the Internet.

### Fourth Modified Example

In the first example embodiment, the employee ID is used as the person ID for identifying the person present in the area. However, the present disclosure is not limited to this, and another ID may be used as the person ID as long as the person present in the area can be identified. For example, a student number of a school, a patient number of a hospital, or a membership number for using a facility may be used as the person ID. In addition, a membership number of a credit card or electronic money used to use a facility or the store 5B may be used as the person ID.

### Fifth Modified Example

In the commodity demand prediction system 10 of the first example embodiment, the ratio of the employees who have purchased the commodity or the ratio of purchasing the commodity by the employee is used as the purchase tendency for the commodity. However, other information may be used as the purchase tendency as long as the purchase possibility of the commodity can be indicated. For example, a purchase tendency registered by the employee may be used as the purchase tendency for the commodity.

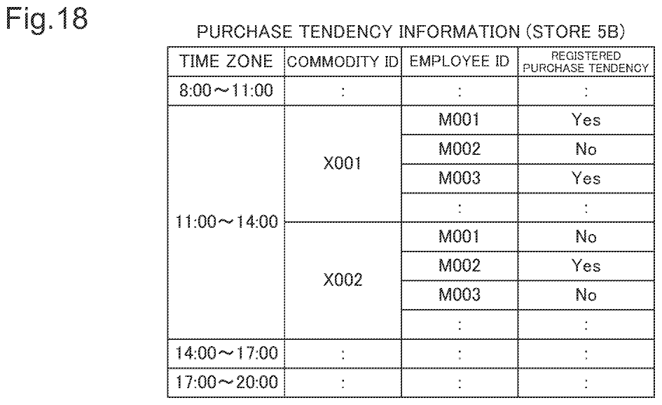

FIG. 18 is a diagram illustrating an example of the purchase tendency information in the fifth modified example of the first example embodiment. In this case, as illustrated in FIG. 18, the time zone, the commodity ID, the employee ID, and a registered purchase tendency are set in the purchase tendency information in association with each other. The registered purchase tendency indicates whether the employee indicated by the employee ID in the office building 2 normally purchases the commodity indicated by the commodity ID in the time zone (Yes) or not (No). The registered purchase tendency may indicate whether the employee wishes to purchase the commodity (Yes) or not (No). The purchase tendency of the employee is transmitted from the employee terminal 400 to the store server 520B, for example, and is registered in the purchase tendency information by the purchase tendency generation unit 524.

For example, the acquisition unit 526 generates, on the basis of the detection information in FIG. 2 or 3, the expected stay information including the employee IDs “M001”, “M003”, and the like for the target time zone “2019/03/01 11:00-14:00” as illustrated in FIG. 12. The prediction unit 527 extracts, from the purchase tendency information in FIG. 18, rows that are associated with sets of the target time zone “2019/03/01 11:00-14:00”, each of the commodity IDs“X001” and “X002”, and each of the employee IDs“M001” and “M003” and in which the purchase wish is “Yes”. The prediction unit 527 calculates the predicted demand number of commodities with the commodity IDs “X001” and “X002” as illustrated in FIG. 16 by summing the number of rows extracted for the commodity IDs.

As a result, a commodity demand reflecting a purchase tendency (purchase wish) registered by each employee can be predicted.

### Second Example Embodiment

Next, a second example embodiment will be described.

The second example embodiment is different from the first example embodiment in that a store server 520B orders a commodity on the basis of a predicted commodity demand.

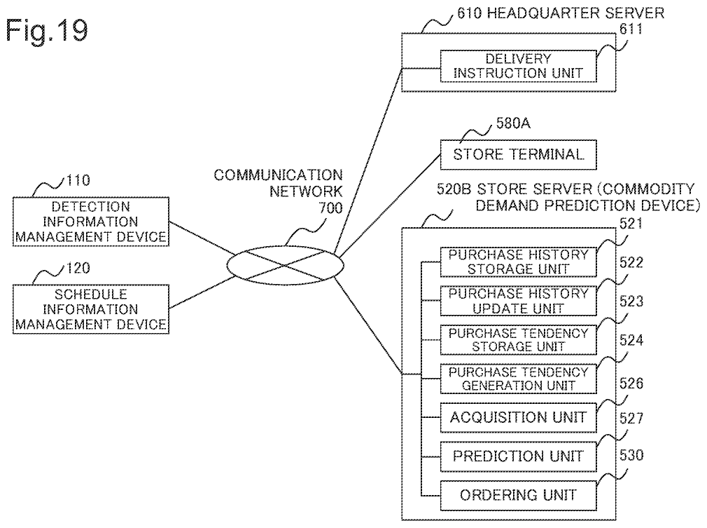

FIG. 19 is a block diagram illustrating details of configurations of the store server 520B and a headquarter server 610 in the second example embodiment. Referring to FIG. 19, the store server 520B of the second example embodiment includes an ordering unit 530 in addition to the components of the store server 520B of the first example embodiment (FIG. 8). The ordering unit 530 performs ordering processing of the commodity on the basis of the predicted demand for the commodity. The ordering processing is, for example, processing of transmitting order information of the commodity to the headquarter server 610 and requesting delivery of the commodity to a store 5.

A store terminal 580A transmits a request to order the commodity to the store server 520B.

In addition, the headquarter server 610 of the second example embodiment includes a delivery instruction unit 611. The delivery instruction unit 611 instructs a delivery center 7 to deliver the ordered commodity to a store 5A on the basis of order data received from the store server 520B.

The store server 520B, an acquisition unit 526, a prediction unit 527, and the ordering unit 530 in the second example embodiment are example embodiments of a commodity demand prediction device, an acquisition means, a prediction means, and an ordering means in the present disclosure, respectively.

Next, an operation of the second example embodiment will be described. The purchase tendency generation processing in the second example embodiment is similar to that in the first example embodiment (FIG. 14).

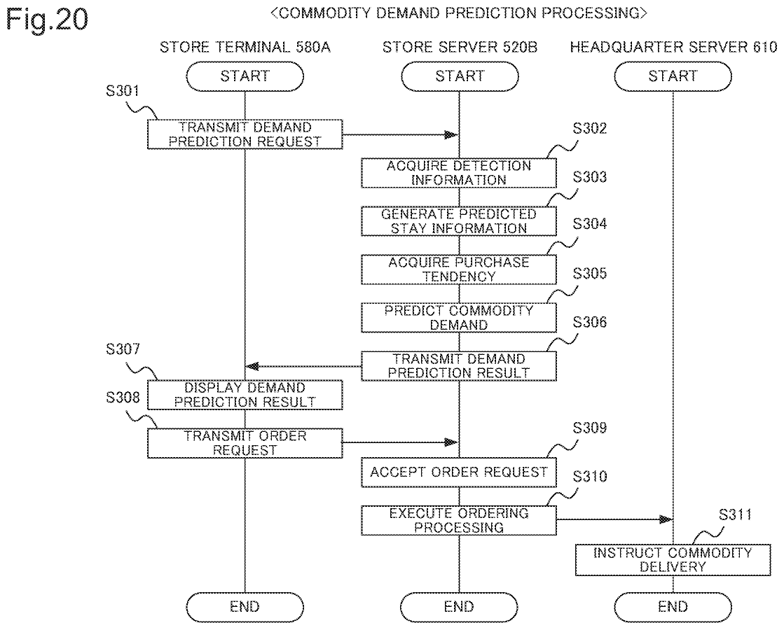

FIG. 20 is a flowchart illustrating commodity demand prediction processing in the second example embodiment. Here, processing from transmission of a demand prediction request by the store terminal 580A to display of a demand prediction result received from the store server 520B (steps S301 to S307) is similar to that in the first example embodiment (steps S201 to S207 in FIG. 15).

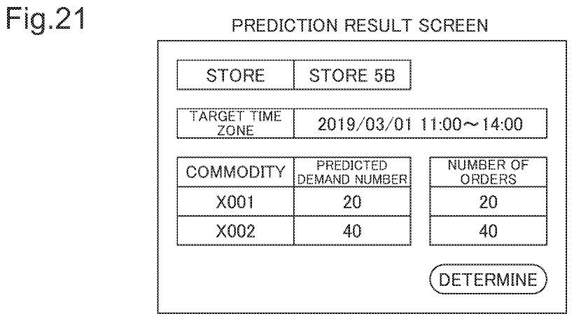

FIG. 21 is a diagram illustrating an example of a prediction result screen in the second example embodiment. In the example of FIG. 21, an input field of the numbers of orders is provided in addition to the predicted demand numbers of commodities. For example, the store terminal 580A displays the prediction result screen in FIG. 21 to a salesclerk.

The salesclerk of the store 5A refers to the demand for the commodity displayed on the prediction result screen, and determines the number of orders or order quantity of commodities in a store 5B.

The store terminal 580A transmits the order request to the store server 520B of the store 5B (step S308). Here, the store terminal 580A accepts, from the salesclerk, designation of the number of orders or order quantity of commodities for which the demand has been predicted, and transmits the order request including the designation. Note that, when the salesclerk does not designate the number of orders or order quantity, the store terminal 580A may designate, as the number of orders or order quantity, the predicted demand number or predicted demand quantity.

For example, the store terminal 580A transmits an order request including the order quantity of commodities with commodity IDs “X001” and “X002”.

The ordering unit 530 of the store server 520B accepts the order request from the store terminal 580A (step S309).

The ordering unit 530 performs the ordering processing for the commodities included in the order request received from the store terminal 580A (step S310). The ordering unit 530 transmits, to the headquarter server 610, the order data including the commodity IDs and the number of orders or order quantity of commodities included in the order request.

For example, the ordering unit 129 of the store server 520B transmits the order data including the commodity IDs “X001” and “X002”.

The delivery instruction unit 611 of the headquarter server 610 instructs the delivery center 7 to deliver the commodities to the store 5A on the basis of the order data received from a store system 500 (step S311). As a result, the commodities are delivered to the store 5B as an order source via the store 5A.

For example, the delivery instruction unit 214 instructs delivery of the commodities with the commodity IDs “X001” and “X002” to the store 5A.

Thus, the operation of the second example embodiment is completed.

Note that the ordering unit 530 may automatically perform the ordering processing by using, as the number of orders or order quantity, the predicted demand number or predicted demand quantity predicted by the prediction unit 527, without using the order request from the store terminal 580. In this case, the commodity demand prediction processing (the demand prediction by the prediction unit 527 and the order by the ordering unit 530) may be executed at a predetermined timing, for example, at a predetermined time every day or the like.

According to the second example embodiment, it is possible to order a commodity that is highly likely to be purchased in a store. This is because the ordering unit 530 performs the ordering processing of the commodity on the basis of the demand for the commodity predicted by the prediction unit 527.

### Third Example Embodiment

Next, a third example embodiment will be described.

The third example embodiment is different from the first example embodiment in that a headquarter server 610 generates purchase tendency information instead of a store server 520B.

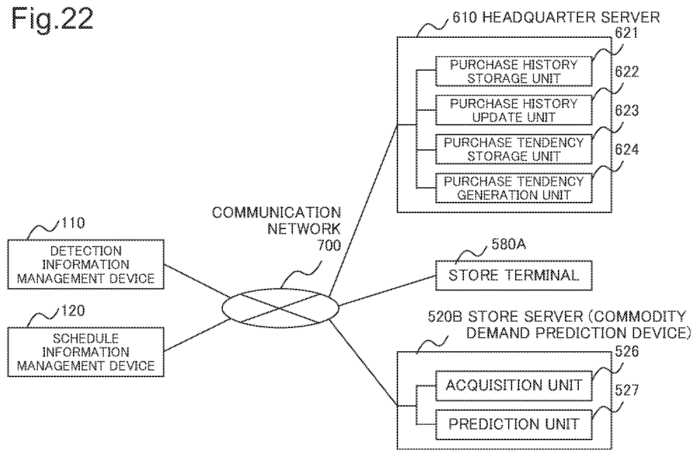

FIG. 22 is a block diagram illustrating details of configurations of the store server 520B and the headquarter server 610 in the third example embodiment. Referring to FIG. 22, the store server 520B includes an acquisition unit 526 and a prediction unit 527 similar to those in the first example embodiment. The headquarter server 610 includes a purchase history storage unit 621, a purchase history update unit 622, a purchase tendency storage unit 623, and a purchase tendency generation unit 624. The purchase history storage unit 621, the purchase history update unit 622, the purchase tendency storage unit 623, and the purchase tendency generation unit 624 have functions similar to those of the purchase history storage unit 521, the purchase history update unit 522, the purchase tendency storage unit 523, and the purchase tendency generation unit 524 of the store server 520B in the first example embodiment.

The purchase history storage unit 621 stores a purchase history of an employee for a commodity in a store 5B.

The purchase history update unit 622 updates the purchase history stored in the purchase history storage unit 621 with purchase data received from a POS device 510 of the store 5B.

The purchase tendency storage unit 623 stores the purchase tendency information.

The purchase tendency generation unit 624 generates the purchase tendency information on the basis of the purchase history in the purchase history storage unit 621, and stores the purchase tendency information in the purchase tendency storage unit 623.

The store server 520B, the acquisition unit 526, and the prediction unit 527 in the third example embodiment are example embodiments of a commodity demand prediction device, an acquisition means, and a prediction means in the present disclosure, respectively.

When the store server 520B receives a demand prediction request from a store terminal 580A, the acquisition unit 526 generates (acquires) expected stay information by using detection information acquired from a detection information management device 110 or schedule information acquired from a schedule information management device 120.

The prediction unit 527 predicts a demand for the commodity in the store 5B in a target time zone on the basis of the purchase tendency information acquired from the purchase tendency storage unit 623 of the headquarter server 610 and the expected stay information acquired by the acquisition unit 526, and transmits the demand to the store terminal 580A.

According to the third example embodiment, similarly to the first example embodiment, a commodity demand in a store can be accurately predicted. This is because the acquisition unit 526 of the store server 520B acquires information regarding a person expected to be present in an area where the store 5B is installed in at least a part of a time zone in which a demand for a commodity is predicted, and the prediction unit 527 predicts the demand for the commodity in the store 5B in the time zone on the basis of the information regarding the person and a purchase tendency of the person for the commodity.

### Fourth Example Embodiment

Next, a fourth example embodiment will be described.

The fourth example embodiment is different from the third example embodiment in that, similarly to the second example embodiment, a store server 520B orders a commodity on the basis of a predicted commodity demand.

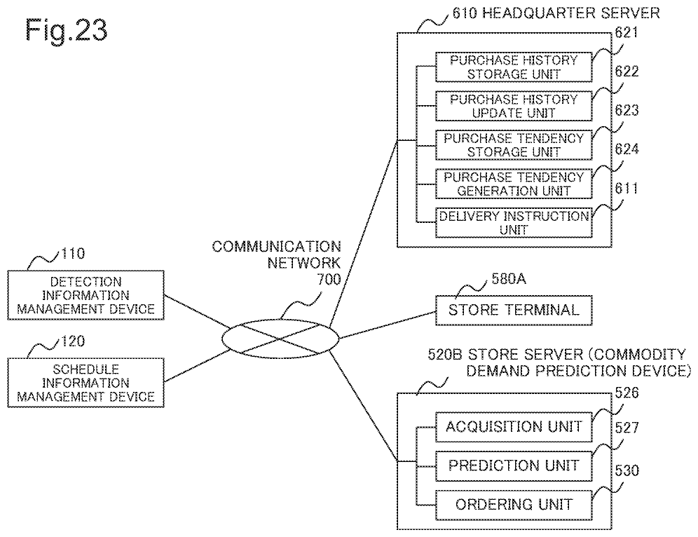

FIG. 23 is a block diagram illustrating details of configurations of the store server 520B and a headquarter server 610 in the fourth example embodiment. Referring to FIG. 23, the store server 520B of the fourth example embodiment includes an ordering unit 530 similar to that in the second example embodiment in addition to the components of the store server 520B of the third example embodiment (FIG. 22). In addition, the headquarter server 610 of the fourth example embodiment includes a delivery instruction unit 611 similar to that in the second example embodiment in addition to the components of the headquarter server 610 of the third example embodiment (FIG. 22).

The store server 520B, an acquisition unit 526, a prediction unit 527, and the ordering unit 530 in the fourth example embodiment are example embodiments of a commodity demand prediction device, an acquisition means, a prediction means, and an ordering means in the present disclosure, respectively.

According to the fourth example embodiment, similarly to the second example embodiment, it is possible to order a commodity that is highly likely to be purchased in a store. This is because the ordering unit 530 performs ordering processing of the commodity on the basis of a demand for the commodity predicted by the prediction unit 527.

### Fifth Example Embodiment

Next, a fifth example embodiment will be described.

The fifth example embodiment is different from the first example embodiment in that a store server 520A predicts a commodity demand.

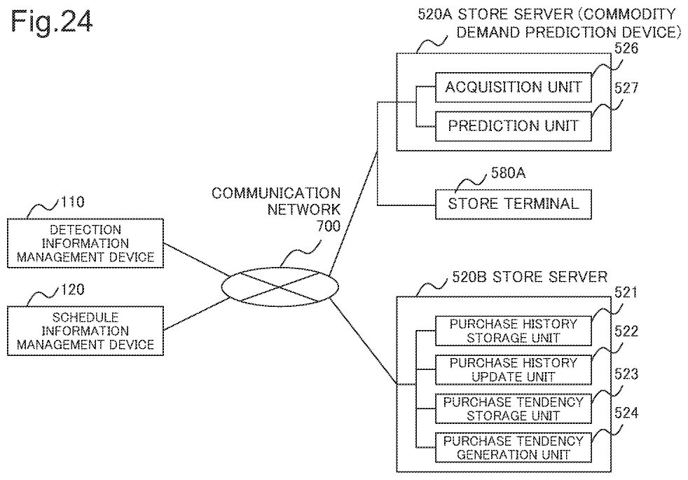

FIG. 24 is a block diagram illustrating details of configurations of the store server 520A and a store server 520B in the fifth example embodiment. Referring to FIG. 24, the store server 520A includes an acquisition unit 526 and a prediction unit 527 similar to those in the first example embodiment. The store server 520B includes a purchase history storage unit 521, a purchase history update unit 522, a purchase tendency storage unit 523, and a purchase tendency generation unit 524 similar to those in the first example embodiment.

The store server 520A, the acquisition unit 526, and the prediction unit 527 in the fifth example embodiment are example embodiments of a commodity demand prediction device, an acquisition means, and a prediction means in the present disclosure, respectively.

A store terminal 580A transmits a demand prediction request to the store server 520A.

When the store server 520A receives the demand prediction request, the acquisition unit 526 generates (acquires) expected stay information by using detection information acquired from a detection information management device 110 or schedule information acquired from a schedule information management device 120.

The prediction unit 527 predicts a demand for a commodity in a store 5B in a target time zone on the basis of purchase tendency information acquired from the purchase tendency storage unit 523 of the store server 520B and the expected stay information acquired by the acquisition unit 526, and transmits the demand to the store terminal 580A.

According to the fifth example embodiment, similarly to the first example embodiment, a commodity demand in a store can be accurately predicted. This is because the acquisition unit 526 of the store server 520A acquires information regarding a person expected to be present in an area where the store 5B is installed in at least a part of a time zone in which a demand for a commodity is predicted, and the prediction unit 527 predicts the demand for the commodity in the store 5B in the time zone on the basis of the information regarding the person and a purchase tendency of the person for the commodity.

Note that the store server 520A may further include an ordering unit 530 similar to that of the second example embodiment.

### Sixth Example Embodiment

Next, a sixth example embodiment will be described.

The sixth example embodiment is different from the first example embodiment in that a headquarter system 600 predicts a commodity demand.

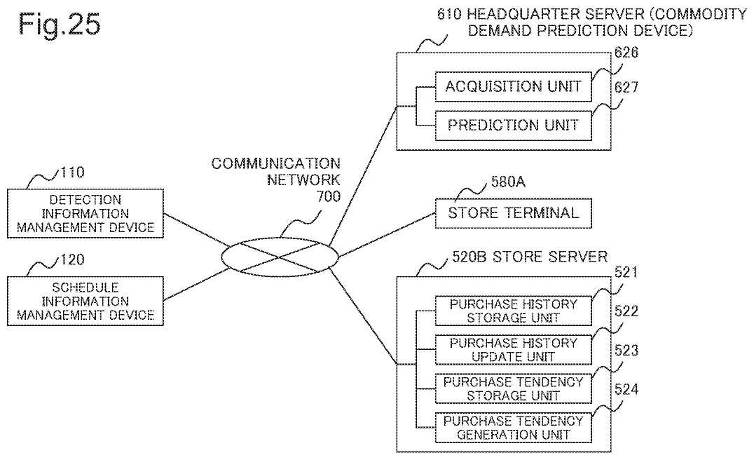

FIG. 25 is a block diagram illustrating details of configurations of a store server 520B and a headquarter server 610 in the sixth example embodiment. Referring to FIG. 25, the store server 520B includes a purchase history storage unit 521, a purchase history update unit 522, a purchase tendency storage unit 523, and a purchase tendency generation unit 524 similar to those in the first example embodiment. The headquarter server 610 includes an acquisition unit 626 and a prediction unit 627. The acquisition unit 626 and the prediction unit 627 have functions similar to those of the acquisition unit 526 and the prediction unit 527 of the store server 520B in the first example embodiment.

The headquarter server 610, the acquisition unit 626, and the prediction unit 627 in the sixth example embodiment are example embodiments of a commodity demand prediction device, an acquisition means, and a prediction means in the present disclosure, respectively.

A store terminal 580A transmits a demand prediction request to the headquarter server 610.

When the headquarter server 610 receives the demand prediction request, the acquisition unit 626 generates (acquires) expected stay information by using detection information acquired from a detection information management device 110 or schedule information acquired from a schedule information management device 120.

The prediction unit 627 predicts a demand for a commodity in a store 5B in a target time zone on the basis of purchase tendency information acquired from the purchase tendency storage unit 523 of the store server 520B and the expected stay information acquired by the acquisition unit 626, and transmits the demand to the store terminal 580A.

According to the sixth example embodiment, similarly to the first example embodiment, a commodity demand in a store can be accurately predicted. This is because the acquisition unit 626 of the headquarter server 610 acquires information regarding a person expected to be present in an area where the store 5B is installed in at least a part of a time zone in which a demand for a commodity is predicted, and the prediction unit 627 predicts the demand for the commodity in the store 5B in the time zone on the basis of the information regarding the person and a purchase tendency of the person for the commodity.

### Seventh Example Embodiment

Next, a seventh example embodiment will be described.

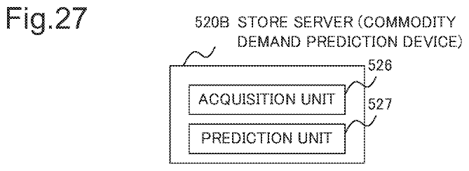

FIG. 27 is a block diagram illustrating a configuration of a store server 520B in the seventh example embodiment.

Referring to FIG. 27, the store server 520B includes an acquisition unit 526 and a prediction unit 527. The acquisition unit 526 acquires information regarding a person expected to be present in an area where a store is installed in at least a part of a time zone in which a demand for a commodity is predicted. The prediction unit 527 predicts the demand for the commodity in the store in the time zone on the basis of the information regarding the person and a purchase tendency of the person for the commodity.

According to the seventh example embodiment, similarly to the first example embodiment, a commodity demand in a store can be accurately predicted. This is because the acquisition unit 526 of the store server 520B acquires information regarding a person expected to be present in an area where the store is installed in at least a part of a time zone in which a demand for a commodity is predicted, and the prediction unit 527 predicts the demand for the commodity in the store in the time zone on the basis of the information regarding the person and a purchase tendency of the person for the commodity.

(Hardware Configuration)

In the above-described example embodiments, components of each device (the POS device 510, the store server 520, the store terminal 580, the headquarter server 610, and the like) each indicate a block of a functional unit. A part or all of the components of each device may be implemented by any combination of a computer 900 and programs.

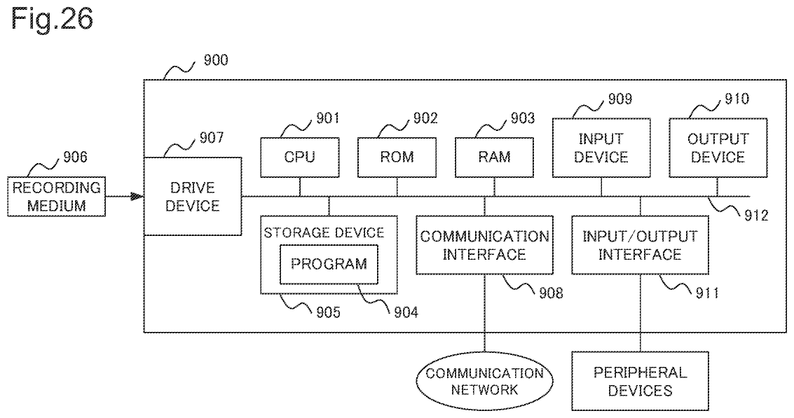

FIG. 26 is a block diagram illustrating an example of a hardware configuration of the computer 900 in the example embodiments. Referring to FIG. 26, the computer 900 includes, for example, a central processing unit (CPU) 901, a read only memory (ROM) 902, a random access memory (RAM) 903, a program 904, a storage device 905, a drive device 907, a communication interface 908, an input device 909, an output device 910, an input/output interface 911, and a bus 912.

The program 904 includes a command (instruction) for implementing functions of each device. The program 904 is stored in the RAM 903 or the storage device 905 in advance. The CPU 901 implements the functions by executing the command included in the program 904. The drive device 907 reads and writes a recording medium 906. The communication interface 908 provides an interface with a communication network. The input device 909 is, for example, a mouse, a keyboard, or the like, and receives an input of information from a manager or the like. The output device 910 is, for example, a display, and outputs (displays) information to the manager or the like. The input/output interface 911 provides an interface with peripheral devices. In the case of the POS device 510, the peripheral devices are the card reader/writer 540, the barcode reader 550, the camera 560, and the tag reader/writer 570 described above. The bus 912 connects the components of the hardware. The program 904 may be supplied to the CPU 901 via the communication network, or may be stored in the recording medium 906 in advance, read by the drive device 907, and supplied to the CPU 901.

Note that the hardware configuration illustrated in FIG. 26 is an example, and another component may be added and a part of the components does not have to be included.

There are various modified examples of a method for implementing each device. For example, each device may be implemented by any combination of computers and programs different for each component. In addition, a plurality of components included in each device may be implemented by any combination of one computer and programs.

In addition, a part or all of the components of each device may be implemented by a general-purpose or dedicated circuit (circuitry) including a processor or the like, or a combination thereof. These circuits may be configured by a single chip or may be configured by a plurality of chips connected via a bus. A part or all of the components of each device may be implemented by a combination of the above-described circuit or the like and a program.

In addition, in a case where a part or all of the components of each device are implemented by a plurality of computers, circuits, and the like, the plurality of computers, circuits, and the like may be arranged in a centralized manner or in a distributed manner.

The store servers 520A and 520B may be arranged in the stores 5A and 5B, respectively, or may be arranged in a place different from the stores 5A and 5B and connected to the POS device 510 and the store terminals 580A and 580B via the communication network 700. That is, the store servers 520A and 520B may be implemented by a cloud computing system. Similarly, the headquarter server 610 may also be implemented by the cloud computing system.

While the present disclosure has been particularly shown and described with reference to example embodiments thereof, the present disclosure is not limited to these embodiments. It will be understood by those of ordinary skill in the art that various changes in form and details may be made therein without departing from the spirit and scope of the present disclosure as defined by the claims. In addition, the configurations in the example embodiments can be combined with each other without departing from the scope of the present disclosure.

A part or all of the above-described example embodiments may be described as the following supplementary notes, but are not limited to the following.

(Supplementary Note 1)

A commodity demand prediction device including:

an acquisition means for acquiring information regarding a person expected to be present in an area where a store is installed in at least a part of a time zone in which a demand for a commodity is predicted; and

a prediction means for predicting the demand for the commodity in the store in the time zone based on the information regarding the person and a purchase tendency of the person for the commodity.

(Supplementary Note 2)

The commodity demand prediction device according to supplementary note 1, wherein

the acquisition means acquires, as the information regarding the person, the number of persons expected to be present in the area in at least a part of the time zone, and

the prediction means predicts the demand for the commodity in the store in the time zone based on the acquired number of persons and purchase tendencies of the persons for the commodity.

(Supplementary Note 3)

The commodity demand prediction device according to supplementary note 1, wherein

the acquisition means acquires, as the information regarding the person, an identifier of a person expected to be present in the area in at least a part of the time zone, and

the prediction means predicts the demand for the commodity in the store in the time zone based on a purchase tendency of the person with the acquired identifier for the commodity.

(Supplementary Note 4)

The commodity demand prediction device according to any one of supplementary notes 1 to 3, wherein

the acquisition means acquires the information regarding the person by using detection information of a person in the area.

(Supplementary Note 5)

The commodity demand prediction device according to supplementary note 4, wherein

the acquisition means acquires the information regarding the person by using the detection information indicating an entry/exit status of the person in the area.

(Supplementary Note 6)

The commodity demand prediction device according to supplementary note 4, wherein

the acquisition means acquires the information regarding the person by using the detection information indicating an operation status of a terminal device of the person in the area.

(Supplementary Note 7)

The commodity demand prediction device according to any one of supplementary notes 1 to 3, wherein

the acquisition means acquires the information regarding the person by using schedule information of a person related to the area.

(Supplementary Note 8)

The commodity demand prediction device according to supplementary note 3, wherein

the prediction means predicts the demand for the commodity in the store in the time zone based on the purchase tendency for the commodity, the purchase tendency being registered by the person with the acquired identifier.

(Supplementary Note 9)

The commodity demand prediction device according to any one of supplementary notes 1 to 8, wherein

the prediction means further outputs the predicted demand for the commodity to a terminal device.

(Supplementary Note 10)

The commodity demand prediction device according to any one of supplementary notes 1 to 9, further including

an ordering means for performing ordering processing of the commodity based on the predicted demand for the commodity.

(Supplementary Note 11)

A commodity demand prediction system including:

a commodity demand prediction device including

an acquisition means for acquiring information regarding a person expected to be present in an area where a store is installed in at least a part of a time zone in which a demand for a commodity is predicted, and

a prediction means for predicting the demand for the commodity in the store in the time zone based on the information regarding the person and a purchase tendency of the person for the commodity; and

a detection information management device that stores detection information of a person in the area, wherein

the acquisition means acquires the information regarding the person by using the detection information of the person in the area, the detection information being acquired from the detection information management device.

(Supplementary Note 12)

A commodity demand prediction system including:

a commodity demand prediction device including

an acquisition means for acquiring information regarding a person expected to be present in an area where a store is installed in at least a part of a time zone in which a demand for a commodity is predicted, and

a prediction means for predicting the demand for the commodity in the store in the time zone based on the information regarding the person and a purchase tendency of the person for the commodity; and

a schedule information management device that stores schedule information of a person related to the area, wherein

the acquisition means acquires the information regarding the person by using the schedule information of the person related to the area, the schedule information being acquired from the schedule information management device.

(Supplementary Note 13)

A commodity demand prediction method including:

acquiring information regarding a person expected to be present in an area where a store is installed in at least a part of a time zone in which a demand for a commodity is predicted; and

predicting the demand for the commodity in the store in the time zone based on the information regarding the person and a purchase tendency of the person for the commodity.

(Supplementary Note 14)

A program that causes a computer to execute processing including:

acquiring information regarding a person expected to be present in an area where a store is installed in at least a part of a time zone in which a demand for a commodity is predicted; and

predicting the demand for the commodity in the store in the time zone based on the information regarding the person and a purchase tendency of the person for the commodity.

This application is based upon and claims the benefit of priority from Japanese patent application No. 2019-055919, filed on Mar. 25, 2019, the disclosure of which is incorporated herein in its entirety by reference.

### REFERENCE SIGNS LIST

1 management center
100 management system
110 detection information management device
120 schedule information management device
2 office building
3 gate
310 card reader/writer
320 barcode reader
330 camera
4 office
400a, 400b, 400c employee terminal
5A, 5B store
500A, 500B store system
510 POS device
511 customer specifying unit
512 registration unit
513 checkout unit
514 purchase data generation unit
520 store server
521 purchase history storage unit
522 purchase history update unit
523 purchase tendency storage unit
524 purchase tendency generation unit
526 acquisition unit
527 prediction unit
530 ordering unit
540 card reader/writer
550 barcode reader
560 camera
570 tag reader/writer
580A, 580B store terminal
6 headquarter
600 headquarter system
611 delivery instruction unit
610 headquarter server
621 purchase history storage unit
622 purchase history update unit
623 purchase tendency storage unit
624 purchase tendency generation unit
626 acquisition unit
627 prediction unit
7 delivery center
700, 800 communication network
900 computer
901 CPU
902 ROM
903 RAM
904 program
905 storage device
906 recording medium
907 drive device
908 communication interface
909 input device
910 output device
911 input/output interface
912 bus
10 commodity demand prediction system

1. A commodity demand prediction device comprising:
at least one memory configured to store instructions; and
at least one processor configured to execute the instructions to:
acquire information regarding a person expected to be present in an area where a store is located in at least a part of a time zone in which a demand for a commodity is predicted; and
predict the demand for the commodity in the store in the time zone based on the information regarding the person and a purchase tendency of the person for the commodity.

2. The commodity demand prediction device according to claim 1, wherein the at least one processor is further configured to execute the instructions to:
acquire, as the information regarding the person, the number of persons expected to be present in the area in at least a part of the time zone, and
predict the demand for the commodity in the store in the time zone based on the acquired number of persons and purchase tendencies of the persons for the commodity.

3. The commodity demand prediction device according to claim 1, wherein the at least one processor is further configured to execute the instructions to:
acquire, as the information regarding the person, an identifier of a person expected to be present in the area in at least a part of the time zone, and
predict the demand for the commodity in the store in the time zone based on a purchase tendency of the person with the acquired identifier for the commodity.

4. The commodity demand prediction device according to claim 1, wherein the at least one processor is further configured to execute the instructions to:
acquire the information regarding the person by using detection information of a person in the area.

5. The commodity demand prediction device according to claim 4, wherein the at least one processor is further configured to execute the instructions to:
acquire the information regarding the person by using the detection information indicating an entry/exit status of the person in the area.

6. The commodity demand prediction device according to claim 4, wherein the at least one processor is further configured to execute the instructions to:
acquire the information regarding the person by using the detection information indicating an operation status of a terminal device of the person in the area.

7. The commodity demand prediction device according to claim 1, wherein the at least one processor is further configured to execute the instructions to:
acquire the information regarding the person by using schedule information of a person related to the area.

8. The commodity demand prediction device according to claim 3, wherein the at least one processor is further configured to execute the instructions to:
predict the demand for the commodity in the store in the time zone based on the purchase tendency for the commodity, the purchase tendency being registered by the person with the acquired identifier.

9. The commodity demand prediction device according to claim 1, wherein the at least one processor is further configured to execute the instructions to:
output the predicted demand for the commodity to a terminal device.

10. The commodity demand prediction device according to claim 1, wherein the at least one processor is further configured to execute the instructions to:
perform ordering processing of the commodity based on the predicted demand for the commodity.

11.-12. (canceled)

13. A commodity demand prediction method comprising:
acquiring information regarding a person expected to be present in an area where a store is located in at least a part of a time zone in which a demand for a commodity is predicted; and
predicting the demand for the commodity in the store in the time zone based on the information regarding the person and a purchase tendency of the person for the commodity.

14. A non-transitory computer-readable recording medium storing a program that causes a computer to execute processing comprising:
acquiring information regarding a person expected to be present in an area where a store is located in at least a part of a time zone in which a demand for a commodity is predicted; and
predicting the demand for the commodity in the store in the time zone based on the information regarding the person and a purchase tendency of the person for the commodity.
